(19) United States
(12) Patent Application Publication
(10) Pub. No.: US 2013/0228387 A1
(43) Pub. Date: Sep. 5, 2013

(54) Drive Battery Arrangement and Motor Vehicle Having a Drive Battery Arrangement

(71) Applicant: Marc Lucas, Remagen - Oberwinter (DE)

(72) Inventor: Marc Lucas, Remagen - Oberwinter (DE)

(73) Assignee: Ford Global Technologies, LLC

(21) Appl. No.: 13/745,953

(22) Filed: Jan. 21, 2013

(30) Foreign Application Priority Data
Jan. 24, 2012 (DE) DE 102012200982.5

(51) Int. Cl. H01M 10/50; B60K 1/04

(52) U.S. Cl. CPC H01M 10/5016; B60K 1/04; H01M 10/5067
USPC 180/65.1; 429/120

(57) ABSTRACT

A vehicle drive battery arrangement, having: two sets of battery cells with a fan device configured therebetween, positioned behind a vehicle seat.

### CROSS-REFERENCE TO RELATED APPLICATIONS

This application is a continuation and claims the benefit of German Patent Application No. DE 102012200982.5 titled “Drive Battery Arrangement and Motor Vehicle Having a Drive Battery Arrangement” filed Jan. 24, 2012, which is hereby incorporated in its entirety.

### TECHNICAL FIELD

The present disclosure relates to a drive battery arrangement for a motor vehicle and cooling methods for the same.

### BACKGROUND

Motor vehicles having a battery electric drive or a hybrid drive (i.e., a hybrid electric vehicle) require drive batteries that are able to absorb a considerable amount of energy. It is generally desirable to cool the drive batteries due to the heat that arises when charging and/or discharging the drive batteries. For this purpose, a plurality of fans can be provided that generate an air flow through the drive batteries and/or through or along its battery cells. Generally, a plurality of drive batteries or battery modules is provided in a motor vehicle having an electric or hybrid drive. Fans on the outer end of the battery pack require additional packaging space for each fan. This space takes away from other vehicle components or storage areas (e.g., the trunk or spare tire).

Therefore it is desirable to have a multiple fan cooling device for a battery pack with more streamlined packaging and simpler installation.

### SUMMARY

The present disclosure addresses one or more of the above-mentioned issues. Other features and/or advantages will become apparent from the description which follows.

One advantage of the present disclosure is that it provides a drive battery arrangement for a motor vehicle having an electric drive or a hybrid drive with increased packaging.

One exemplary embodiment of the present disclosure relates to a drive battery arrangement for a motor vehicle having a hybrid drive, including: at least two drive batteries; and a fan device configured to cool the drive batteries. The fan device is arranged between the at least two drive batteries.

Another exemplary embodiment of the present disclosure relates to a vehicle having a hybrid drive, including: a drive battery arrangement with at least two drive batteries; and a fan device arranged between the at least two drive batteries and configured to cool the drive batteries.

Another exemplary embodiment of the present disclosure relates to a vehicle drive battery arrangement, having: two sets of battery cells with a fan device configured therebetween, positioned behind a vehicle seat.

The invention will be explained in greater detail below by way of example with reference to the figures, in which the same reference numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIG. 1 is a perspective view of a vehicle battery pack with cooling fans according to an exemplary embodiment of the present disclosure.

FIG. 2 is a partial perspective view of the battery pack of FIG. 1.

FIG. 3 is a perspective view of the vehicle battery pack of FIG. 1 on top of a floor sheet metal plate.

### DETAILED DESCRIPTION

Referring to the drawings, wherein like characters represent examples of the same or corresponding parts throughout the several views, there is shown an exemplary embodiment of a vehicle drive battery arrangement (or vehicle battery pack) for use with a hybrid electric or all electric vehicles. The battery pack includes a fan device that has multiple fans configured between battery modules so as to reduce the required packaging space for the fans. Other electronic devices, such as an electric assembly are cooled by the fan device. The disclosed vehicle drive battery arrangement is configured for use in any type of vehicle, including sedans, coupes, SUVs or pick-up trucks.

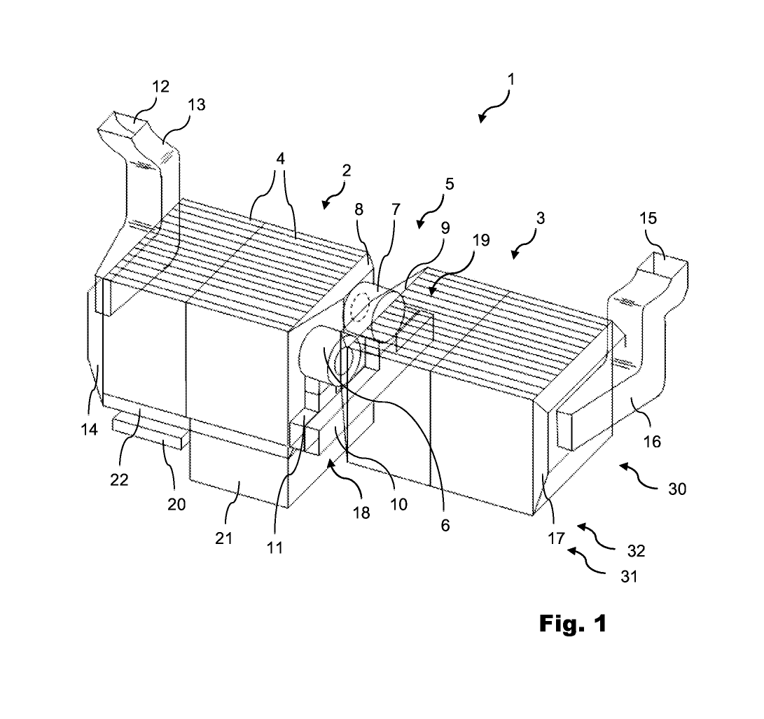

Referring now to FIG. 1, a drive battery arrangement 1 includes two drive batteries 2, 3 that each includes a plurality of cells 4. The two drive batteries, 2, 3 are arranged at mutually-spaced dispositions with respect to each other. There is an intermediate space between the drive batteries 2, 3 that receives a fan device 5. The fan device 5 comprises two fans 6, 7, air collectors 8, 9 and exhaust air ducts 10, 11. The air collector 8 is used to draw air, in a uniform manner, through the cells 4 of the first drive battery 2. Air flow is directed through the air inlet 12 and the air supply duct 13 and the air distributor 14. Air is delivered to the cells 4 of the drive battery 2. The air that is heated as it flows through the cells 4, drawn in by way of the air collector 8 into the fan 7, and passes from the fan into the exhaust air duct 10.

In order to cool drive battery 3, as shown in FIG. 1, air is drawn by the fan 6 through the cells of the drive battery 3. Cooling air is directed through an air inlet 15, air supply duct 16 and air distributor 17. Air is delivered to the cells of the second drive battery 3 and is guided through the air collector 9 into the fan 6. The air supply ducts 13, 16 can each be embodied differently according to structural conditions when they are installed in the motor vehicle. The air drawn in by the fan 6 passes into the exhaust air duct 11. The exhaust air ducts 10, 11 form an outlet duct 18 on one side and an outlet duct 19 on an opposite side.

An electronic control device 20 and a DC-converter 21 are arranged below the first drive battery 2 and can include, in each case, a dedicated housing having corresponding internal air ducts. The air distributor 14 and the air collector 8 are embodied in such a manner that, by means of an additional air duct 22, cooling air is directed to the control device 20 and to the DC-converter 21. The air that is drawn in by the fan 7 in order to cool the electronic assemblies of the control device 20 and the DC-converter 21 likewise passes into the exhaust air duct 10.

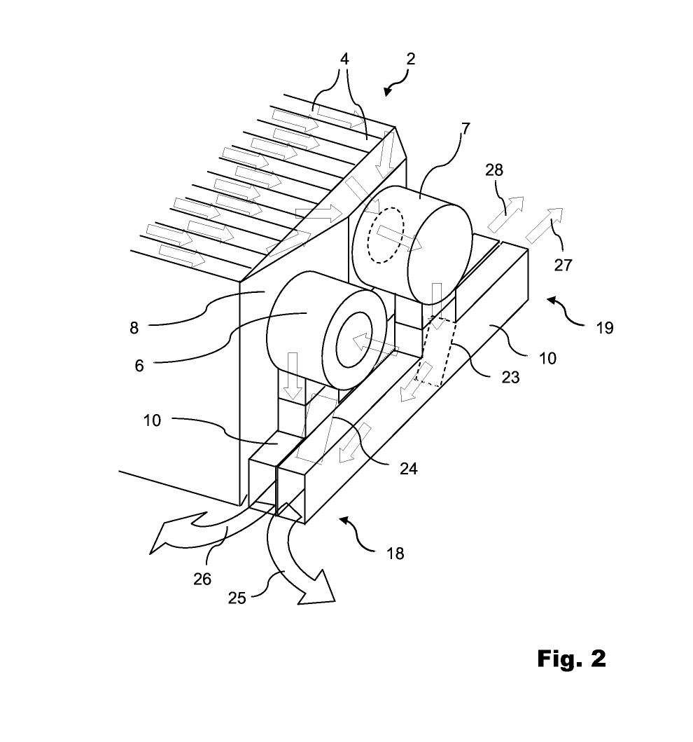

FIG. 2 illustrates in detail air flow through the fan device, a drive battery 3 having air ducts, the control device 20, the DC-converter 21 and other components or air ducts. The arrows shown indicate a direction of flow of the air that is drawn in by fans 6, 7 through the drive batteries. As illustrated in FIG. 2, an air duct flap 23, 24 is arranged in the exhaust air ducts 10, 11, respectively. When the air duct flaps 23, 24 are in the position as illustrated in FIG. 2, air flow is directed to a first outlet duct 18 that is formed by a first end of the exhaust air ducts 10, 11 and through which the air flow passes, for example, into a vehicle passenger compartment where it is distributed (as indicated by the wide arrows 25, 26). When air duct flaps 23, 24 are in another position not illustrated in FIG. 2, the air flow is directed to the outlet duct 19 that is formed by an end of the exhaust air ducts 10, 11 and through which the air flow can pass, for example, into a storage space or to the outside of the vehicle (as indicated in FIG. 2 by arrows 27, 28). The air duct flaps 23, 24 can also assume an intermediate position, whereby air flow can be divided between the first outlet duct and the second outlet duct. For this purpose, it is also possible to provide a different position and/or to actuate the duct flaps 23, 24 independently of each other.

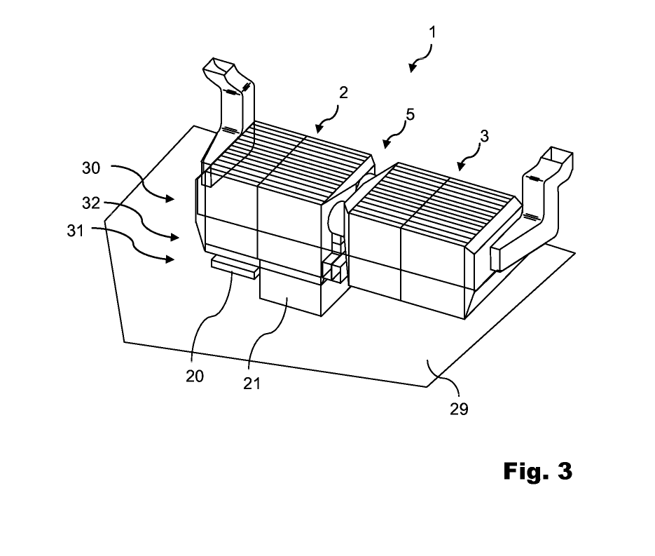

Now turning to FIG. 3, which illustrates an exemplary installation of the drive battery arrangement 1 in a vehicle 100. The drive batteries 2, 3 and the fan device 5 are arranged partially above a floor sheet metal plate 29 of the storage space. In a front region (on the left side in FIG. 3) of the floor sheet metal plate 29, this can extend under a rear row of seats in the motor vehicle, e.g., 110. The control device 20 and the DC-converter 21 are completely arranged below the floor sheet metal plate 29. As a consequence, it is possible to make particularly good use of the available installation space, in particular of the space between a subframe and the floor sheet metal plate 29.

As is evident in FIG. 1 and FIG. 3, the drive battery arrangement 1 is embodied in two layers. Drive batteries 2, 3 have the allocated air ducts and the fan device 5 form an upper layer 30, whereas the electronic assemblies, such as the control device 20 and the DC-converter 21, that are allocated to the drive battery arrangement 1 form a lower layer 31. The upper and the lower layer 30, 31, respectively are separated by a horizontal intermediate plane 32. The lower layer 31 and the intermediate plane 32 are arranged in the installation situation illustrated in FIG. 3, below the floor sheet metal plate 29, whereas the upper layer 30 is placed partially below and partially above the floor sheet metal plate 29.

Other arrangements for the battery pack can be effectuated. In accordance with the illustrated embodiment, the fan device is arranged between the least two drive batteries. In particular, the fan device is arranged centrally within the drive battery arrangement and is surrounded at least on two sides by at least two drive batteries. In the event that the drive battery arrangement comprises only two drive batteries, the fan device is consequently arranged between the two drive batteries.

By virtue of the fact that the fan device is arranged between the drive batteries, a particularly compact and space-saving arrangement is produced, while simultaneously ensuring that any heat arising during operation is discharged. As a consequence, it is rendered possible to make better use of the space available in a motor vehicle for installing the drive battery arrangement. In particular, owing to the compact design of the battery arrangement, the battery arrangement can be installed in a motor vehicle in a lower position and consequently between the side frames of the motor vehicle. As a consequence, a central installation position of the drive batteries can be achieved with a greater packaging disposition with respect to the wheel arch sheet metal plates. It is possible in this manner to reduce the complexity of the body work; in addition, additional components for providing protection in the event of a collision can possibly be omitted. As a consequence, the overall complexity of the motor vehicle is reduced, as are weight and manufacturing costs. Finally, it is possible to make better use of the storage space volume and to attach lashing straps in an improved manner.

In accordance with another embodiment of the present disclosure, the drive battery arrangement comprises a control unit of the drive battery arrangement, a DC-converter (DC/DC converter) and/or a storage control switching arrangement. In addition, the two drive batteries are arranged in an upper position or layer of the drive battery arrangement, in particular in an upper plane of the drive battery arrangement and the electronic assembly is arranged in a lower layer or plane of the drive battery arrangement, e.g., as shown in FIG. 1. The electronic assemblies allocated to the drive battery arrangement generally require a comparatively smaller amount of installation space than the drive batteries themselves. By virtue of the fact that the electronic assembly is arranged in the lower layer and/or plane and consequently in a space region below the drive batteries, it is possible to make better use of the installation space available for the drive battery arrangement, in particular the space between the rear subframe and the storage space floor of the motor vehicle.

In accordance with a particularly preferred embodiment of the invention, the drive battery arrangement has two drive batteries, where the electronic assembly is arranged below only one of the drive batteries. The electronic assembly is consequently placed below the drive battery that is arranged on a side of the fan device. As a consequence, a further more compact arrangement is possible.

In an advantageous manner, a switching flap in order to switch between the first outlet duct and the second outlet duct can be provided; the switching flap can also include intermediate positions for dividing the air flow between the two outlet ducts. The switching flap can be actuated in a manual, pneumatic, electric or other manner and can, for example, be automatically switched within the scope of an automatic air-conditioning system in order to heat the motor vehicle passenger compartment. In particular, an exhaust air duct can be allocated to each fan, which exhaust air duct leads into the first outlet duct and into the second outlet duct, and a switching flap that is arranged in the exhaust air duct. As a consequence, it is rendered possible in a particularly simple and effective manner to accordingly use as required the heat contained in the air.

A motor vehicle in accordance with one embodiment has a battery electric drive or hybrid drive with a drive battery arrangement that is embodied as described above. In particular, the drive battery arrangement is installed behind a rear row of seats in the motor vehicle between the side frames of the motor vehicle and above a subframe and at least partially below a storage space floor plane, in particular below a floor sheet metal plate of the storage space. As a consequence, it is rendered possible to accommodate the battery arrangement within the motor vehicle in a particularly reliable manner where the battery arrangement is, in particular, especially well protected against a lateral collision. In addition, it is consequently rendered possible to use the available installation space particularly well and to considerably avoid a reduction in the storage space volume. Finally, the air-conditioning facility is improved by virtue of the available air that has been heated as the batteries are cooled.

In another advantageous manner, the electronic assembly can be arranged below the drive battery on a right hand side or on a left hand side of the motor vehicle. By virtue of the asymmetric arrangement of the electronic assembly, i.e. offset to one side, the installation space below the drive battery or drive batteries, arranged on the respective other side of the motor vehicle, is available for other devices of the motor vehicle, such as for example, for routing exhaust gas pipes or other lines.

Those familiar with the art to which this invention relates will recognize various alternative designs and embodiments for practicing the invention within the scope of the appended claims.

We claim:

1. A drive battery arrangement for a motor vehicle having a hybrid drive, comprising:
at least two drive batteries; and
a fan device configured to cool the drive batteries;
wherein the fan device is arranged between the at least two drive batteries.

2. The drive battery arrangement as claimed in claim 1, further comprising:
an electronic assembly;
wherein the at least two drive batteries are arranged in an upper layer of the drive battery arrangement; and
wherein the electronic assembly is arranged in a lower layer of the drive battery arrangement.

3. The drive battery arrangement as claimed in claim 2, wherein the electronic assembly is arranged below one of the drive batteries.

4. The drive battery arrangement as claimed in claim 1, wherein the fan device comprises: a first fan configured to cool a first drive battery and a second fan is configured to cool a second drive battery.

5. The drive battery arrangement as claimed in claim 4, wherein the first fan is further configured to cool the electronic assembly.

6. The drive battery arrangement as claimed in claim 1, wherein the fan device is configured to draw in air by the at least two drive batteries and to selectively discharge drawn-in air into a first outlet duct or a second outlet duct.

7. A vehicle having a hybrid drive, comprising:
a drive battery arrangement with at least two drive batteries; and
a fan device arranged between the at least two drive batteries and configured to cool the drive batteries.

8. The vehicle of claim 7, wherein the drive battery arrangement is positioned behind a rear row of seats.

9. The vehicle of claim 8, wherein the drive battery arrangement is positioned at least partially below a storage space floor sheet metal plate of the motor vehicle.

10. The vehicle of claim 9, wherein the at least two drive batteries are arranged at least partially below the storage space floor plane.

11. The vehicle of claim 7, wherein the drive battery arrangement further includes an electronic assembly;
wherein the at least two drive batteries are arranged in an upper layer of the drive battery arrangement; and
wherein the electronic assembly is arranged in a lower layer of the drive battery arrangement.

12. The vehicle of claim 11, wherein the electronic assembly is arranged below one of the drive batteries.

13. The vehicle of claim 7, wherein the fan device comprises:
a first fan configured to cool a first drive battery; and
a second fan configured to cool a second drive battery.

14. The vehicle of claim 11, wherein the first fan is further configured to cool the electronic assembly.

15. The vehicle of claim 7, wherein the fan device is configured to draw in air by the at least two drive batteries and to selectively discharge drawn-in air into a first outlet duct or a second outlet duct.

16. A vehicle drive battery arrangement, comprising:
two sets of battery cells with a fan device configured therebetween, positioned behind a vehicle seat.

17. The vehicle drive battery arrangement of claim 16, further comprising:
an electronic assembly;
wherein the at least two drive batteries are arranged in an upper layer of the drive battery arrangement and the at least one electronic assembly is arranged in a lower layer of the drive battery arrangement.

18. The drive battery arrangement of claim 17, wherein the electronic assembly is arranged below one of the drive batteries.

19. The drive battery arrangement of claim 18, wherein the fan device comprises: a first fan configured to cool a first drive battery and a second fan is configured to cool a second drive battery.

20. The drive battery arrangement of claim 19, wherein the first fan is further configured to cool the electronic assembly.
